(19) United States
(12) Patent Application Publication
(10) Pub. No.: US 2009/0197163 A1
(43) Pub. Date: Aug. 6, 2009

(54) High rate primary lithium battery with solid cathode

(76) Inventor: Joseph B. Kejha, Meadowbrook, PA (US)

Correspondence Address: Zachary T. Wobensmith, III, 7746 101st Court, Vero Beach, FL, 32967-2871, US

(21) Appl. No.: 12/381,740

(22) Filed: Mar. 17, 2009

Related U.S. Application Data
(63) Continuation-in-part of application No. 11/107,569, filed on Apr. 18, 2005.

(51) Int. Cl. H01M 2/02

(52) U.S. Cl. 429/163; 977/773

(57) ABSTRACT

A safe high rate primary lithium battery with solid cathode and a lithium anode is provided, having a high rate of discharge and higher energy density due to the lithiated cathode materials contained therein.

### CROSS REFERENCE TO RELATED APPLICATIONS

This application is a continuation in part application of my prior application Ser. No. 11/107,569 filed Apr. 18, 2005

### CROSS REFERENCE TO RELATED DOCUMENTS

The subject matter of this invention is shown and described in the disclosure document of Joseph B. Kejha, document No. 546,575 filed Feb. 9, 2004 and entitled “High Rate Primary Lithium Battery With Solid Cathode and Low Temperature Secondary Lithium Battery”.

### BACKGROUND OF THE INVENTION

1. Field of the Invention

This invention relates to high rate lithium batteries with solid cathodes.

2. Description of the Prior Art

It has been recognized that there is a need for a safe high rate primary lithium battery, and which has a higher energy density than lithium-ion batteries.

High rate lithium primary batteries with liquid cathodes (catholytes), such as thionylchloride, or S0₂ are known in the art, but suffer from their propensity to overheat, and these catholytes are very dangerous as they cause excessive pressure and leaks, and also which have an inherent corrosive nature and low boiling point.

Prior art lithium batteries with solid cathodes have high energy density, and are safer than lithium batteries with liquid cathodes, but the prior art batteries with solid cathodes suffer from an inherently low discharge rate.

To achieve the desired high rate characteristics of lithium primary batteries, the typical solid cathode material (such as Mn0₂, CFₓ, etc.) is replaced with lithiated cobalt oxide (LiCₒ0₂) or lithiated manganese oxide spinel (LiMn₂0₄), or other lithiated high discharge rate materials, and preferably these lithiated materials should be in the form of nano-sized particles.

### SUMMARY OF THE INVENTION

It has now been found that high rate primary lithium battery with solid cathode, which is safer than a high rate lithium battery with a liquid cathode, can be obtained by using cathodes of lithiated high discharge rate materials.

The principal object of the invention is to provide a primary, high discharge rate lithium battery with a solid cathode that has a higher energy density than lithium-ion batteries.

A further object of the invention is to provide a primary high-discharge rate battery of the character aforesaid, which has low self discharge.

A further object of the invention is to provide a battery of the character aforesaid which is simple and inexpensive to construct.

A further object of the invention is to provide a battery of the character aforesaid which is durable and long lasting in service.

A further object of the invention is to provide a battery of the character aforesaid which is particularly suitable for mass production.

Other objects and advantageous features of the invention will be apparent from the description and claims.

### DESCRIPTION OF THE PREFERRED EMBODIMENTS

The nature and characteristic features of the invention will be more readily understood from the following description taken in connection with the accompanying drawing forming part thereof in which:

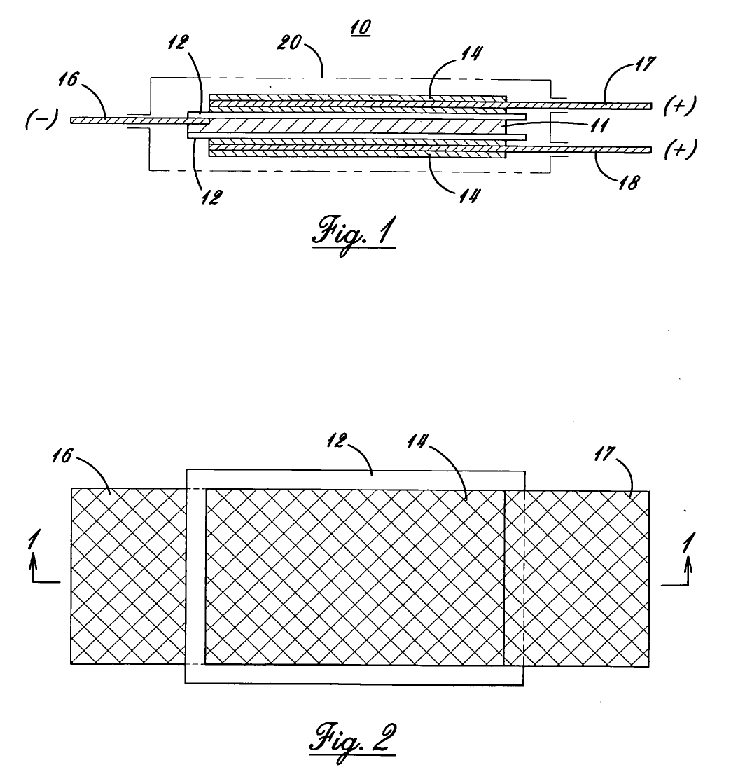

FIG. 1 is a vertical sectional view of a battery constructed in accordance with the invention, and

FIG. 2 is a top plan view of a battery constructed in accordance with the invention.

It should, of course, be understood that the description and drawing herein are merely illustrative, and that various modifications and changes can be made in the structures disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiments, but also technical equivalents, which operate and function in substantially the same way to bring about the same result.

Referring now to the drawings a preferred primary cell or battery 10 is therein illustrated, which is shown as a prismatic bi-cell. The cell 10 has an anode 11 in the middle, which is of lithium foil, with a separator 12 on each side, laminated and preferably welded to cathodes 14 and 15, which are located on each side of the anode 11. The separators 12 are in contact with the anode 11. The separators are preferably constructed of porous ultrathin Teflon, (polytetrafluoethylene) with a thickness of 0.5 to 1.0 mil, and having a porosity of 35% to 60%, which is available from W. L. Gore and Associates, Inc., Dallas, Tex., but can be of any suitable polymer which is ionically conductive and preferably non-reactive with lithium.

The anode 11 has a collector 16 attached thereto, preferably of copper and the cathodes 14 and 15 have collector grids 17 and 18 engaged therewith.

The collector grids 17 and 18 are preferably of aluminum, and preferably have full width terminal tabs. (not shown) The cell 10 is enclosed in a leak and moisture proof container 20 of well-known type.

The cathodes 14 and 15 are preferably formed of a lithiated high discharge rate material, such as lithiated cobalt oxide (LiCₒ0₂), or lithiated manganese oxide spinel (LiMn₂0₄), or a lithiated mixed oxide, and more preferably of any lithiated cathode material comprised of nano sized particles.

The cell 10 is activated by an electrolyte and preferably 1M LiPF₆/EC/DMC/EMC, where LiPF₆ is a highly conductive lithium salt, EC is ethylene carbonate, DMC is dimethyl carbonate and EMC is ethylmethyl carbonate, and in which the carbonates are in a 1:1:1 weight ratio, and where M=mole, and LiPF₆ is lithium hexafluorophosphate. The light weight lithium metal anodes provide higher energy density than lithium-ion type cells, with the same type cathode materials. It should be noted that the bi-cell can also be reversed, with the cathode in the middle and the two anodes on the outside.

Upon assembly of the cell it is initially preferably charged one time to 4.3 volts or any safe and desired voltage, which causes lithium from the cathodes to plate onto the anode, but does not cause dendrite growth of any danger and does not cause shorting.

The cell 10 is then ready for a high rate discharge rate, as a primary cell, and can achieve at least 2C and up to a 50C discharge rate, or more, at room temperature, and at 100% depth of discharge (DOD) where 1C=1 hour discharge rate to full depth of discharge, usually from 4.3 volts to a 3.0 volts, or to 0.1 have found, that these discharge rares are possible due to immediate availability of lithium from the surface of the lithium foil anode, and not possible with li-ion cells. This is an unexpected result. Also, current lithium primary cells do not have this capability, due to non-lithiated cathodes

The self discharge rate of the cell is usually very low compared to Lithium-ion cells. This very low rate is due to the passivating layer on the lithium anode surface, and which is similar to that found with other primary lithium batteries. The high 3.7 volt nominal voltage also increases energy density of a multicelled battery, over other primary batteries, resulting in less cells required in series, which also reduces the assembly cost.

The cells described may also be of other types of construction, such as rolled cylindrical, rolled flat “prismatic” etc., but the described materials of the electrodes and The described methods must be used to achieve similar results.

It will thus be seen that safe high rate primary lithium batteries with solid cathodes, are described, with which the objects of the invention are achieved.

I claim:

1. A high rate primary lithium battery with solid cathode which comprises:
At lease one cathode of lithiated high discharge rate material capable of at least 20C rate,
at least one anode of lithium metal foil,
a current collector engaged with said anode,
a separator in contact with said cathode and in contact with said anode,
a current collector engaged with said cathode.
an electrolyte contained in said separator and in contract with said anode and said cathode, and
a leak and moisture proof enclosure surrounding said anode, said cathode said separator, and said electrolyte,
whereby a higher energy density and power density and low self discharge battery than a lithium-ion battery is achieved.

2. A battery as defined in claim 1 in which;
said battery is a bi-cell having a central anode, a separator on each side, and a cathode on each side thereof.

3. A battery as defined in claim 1, in which;
said battery is a bi-cell having a central cathode, a separator on each side, and,
an anode on each side thereof.

4. A battery as defined in claim 1 in which said separator is of polytetrafluoroethylene with a thickness of 0.5 to 1.0 mil, and a porosity of 35 to 60%.

5. A battery as defined in claim 1 in which;
said cathode material contains a lithiated cobalt oxide.

6. A battery as defined in claim 1 in which;
said cathode contains a lithiated manganese oxide spinel.

7. A battery as defined in claim 1 in which;
said electrolyte comprises one mole of lithium hexafluorophospate salt, in ethylene carbonate, dimethyl carbonate and ethylmethyl carbonate having a 1:1:1 weight ratio.

8. A battery as defined in claim 1 in which;
said lithiated cathodic material is in the form of nano-particles.

9. A battery as defined in claim 1 which is first charged prior to use as a primary battery.
